(19) United States
(12) Patent Application Publication
(10) Pub. No.: US 2018/0338295 A1
(43) Pub. Date: Nov. 22, 2018

(54) Establish Data Radio Bearer During Location Update

(71) Applicant: MEDIATEK INC., Hsinchu (TW)

(72) Inventor: Zong-Syun Lin, Kaohsiung City (TW)

(21) Appl. No.: 15/597,485

(22) Filed: May 17, 2017

(51) Int. Cl. H04W 60/04; H04W 4/02; H04L 29/06; H04W 72/04; H04W 76/04; H04W 56/00

(52) U.S. Cl. CPC H04W 60/04; H04W 4/025; H04L 65/1006; H04W 56/001; H04W 72/0413; H04W 76/046; H04L 65/1016

(57) ABSTRACT

A solution of establishing a data radio bearer via location update such that a user equipment (UE) can synchronize the UE capability with a network application server is provided. When a UE location changes, the UE will send a location update request to the network for such change including RAT change or service capability change etc. The UE can notify the network to establish the DRB by setting a flag in the location update request while in RRC Idle mode. The UE will set this flag when there is pending uplink data, e.g., a new SIP REGISTER message. As a result, the network can establish the DRB upon receiving the location update request, and then the UE is able to send the new SIP REGISTER message to the application server to synchronize the UE capability without incurring additional delay.

### TECHNICAL FIELD

The disclosed embodiments relate generally to wireless communication, and, more particularly, to method of synchronization of UE capability and registration status during location update.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards.

As set forth in the 3GPP, IP Multimedia Subsystem (IMS) is a core network that provides IP multimedia services to user equipments (UEs) over an Internet Protocol (IP) network. Historically, mobile phones have provided voice call services over a circuit-switched (CS) network, rather than strictly over an IP packet-switched (PS) network. Alternative methods of delivering voice or other multimedia services over IP have become available on smartphones (e.g. VoIP or Skype), but they have not become standardized across the industry. IMS is an architectural framework to provide such standardization. IMS is able to communicate with UEs through different types of access network, such as a wireless local area network (WLAN), an Ethernet network, a packet data network (PDN), or another type of access network. IMS is a new way to dial PS call on LTE (Voice over IP or Voice over LIE) instead of fallback to 2G/3G legacy CS call.

Rich Communication Services (RCS) a communication protocol between mobile-telephone carriers and between phone and carrier, aiming at replacing short message service (SMS) messages with a text-message system that more rich, provide phonebook polling (for service discovery), and transmit in-call multimedia. RCS combines different services defined by 3GPP and Open Mobile Alliance (OMA) with an enhanced phonebook. Another phone's capabilities and presence information can be discovered and displayed by a mobile phone. RCS reuses 3GPP specified IMS system as the underlying service platform taking care of issues such as authentication, authorization, registration, charging and routing.

Both IMS and RCS contain several application services such as voice call (VoLTE), SMS, instant message (IM), discovery presence (DP) etc. over the IP network. A UE will send SIP REGISTER to the network to inform UE's capability. When the UE capability change for an IMS registered UE, the UE will send a new SIP REGISTER message with the latest capability to the network. The SIP REGISTER message contains uplink data, which can only be sent over an established data radio bearer (DRB). If the UE is in radio resource control (RRC) idle mode, the network may not establish DRB for the ink data transmission. In this scenario, the UE needs to wait for RRC connection release then request to establish a DRB if there is pending uplink data. If the SIP REGISTER sent failed, UE will start a time to resend the SIP REGISTER message. During the retransmission, the registration status between UE and the network is un-sync. As a result, the network may use wrong way to notify UE for acquiring service. In one example, the service attempt may fail. In another example, the service attempt may succeed if the network retries other UE supported way, but the performance is affected.

A solution is sought.

### SUMMARY

A solution of establishing a data radio bearer via location update such that a user equipment (UE) can synchronize the UE capability with a network application server is provided. When a UE location changes, the UE will send a location update request to the network for such change including RAT change or service capability change etc. The UE can notify the network to establish the DRB by setting a flag in the location update request while in RRC Idle mode. The UE will set this flag when there is pending uplink data, e.g., a new SIP REGISTER message. As a result, the network can establish the DRB upon receiving the location update request, and then the UE is able to send the new SIP REGISTER message to the application server to synchronize the UE capability without incurring additional delay.

In one embodiment, a UE detects a location update in a cellular radio communication network, which triggers a location update request to be sent to the network. The UE detects a UE capability change of a list of session initiation protocol-based (SIP-based) services, which triggers pending uplink data to be sent to an application server to synchronize the UE capability change. The UE transmits the location update request to the network after determining the UE capability has changed when the UE is in radio resource control (RRC) Idle mode. The location update request indicates the pending uplink data to be sent. The UE establishes a data radio bearer (DRB) with the cellular radio network upon receiving a location update accept in response to the location update request. The DRB is established for sending the uplink data.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network supporting session initiation protocol (SIP) based application services with location update in accordance with one novel aspect.

FIG. 2 illustrates simplified block diagrams of a user equipment (UE) and a base station (BS) and an application server in accordance with embodiments of the current invention.

FIG. 3 illustrates a first embodiment of UE capability change when moving to a different cell, which triggers location update in accordance with embodiments of the current invention.

FIG. 4 illustrates a second embodiment of user initiated UE capability change when UE location change, which triggers location update in accordance with embodiments of the current invention.

FIG. 5 is a flow chart of a method of establishing data radio bearer using location update for UE capability synchronization in accordance with one novel aspect.

### DETAILED DESCRIPTION

Reference will now be made in detail to some embodiments of the invention, examples of which are illustrated in the accompanying drawings.

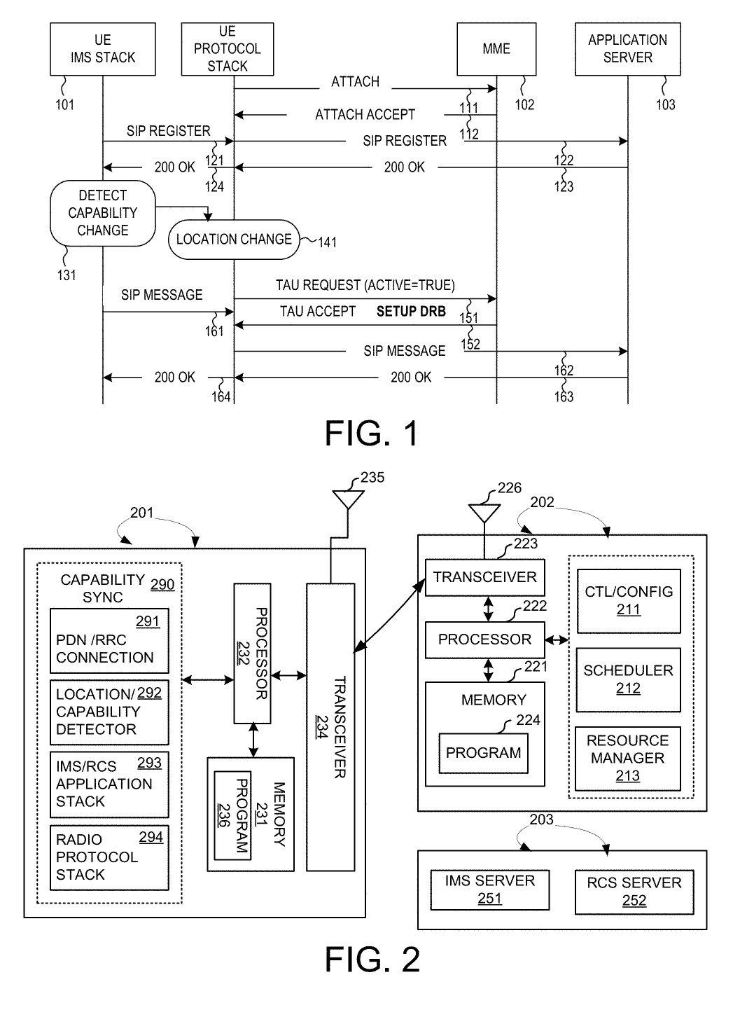

FIG. 1 illustrates a mobile communication network supporting session initiation protocol (SIP) based application services with location update in accordance with one novel aspect. The mobile communication network comprises a user equipment UE 101, a mobility management entity MME 102, and an application server 103. The mobile communication network supports different services through different radio access technologies (RATs) or different service domains. UE 101 may be equipped with a single radio frequency (RF) module/transceiver or multiple RF modules/transceivers for services via different RATs/service domains. UE 101 may be a smart phone, a wearable device, an Internet of Things (IoT) device, a tablet, etc. Here, a service may include voice services such as normal call, emergency call, supplementary service and data services includes short message service (SMS) and other data services (e.g., web browsing and file transfer on the Internet). For voice service, a service domain may include circuit-switched (CS) service domain, packet-switched (PS) service domain, and IMS service domain. For data service, a service domain may include different RATS of 2G/3G/4G and Wi-Fi technology.

The application server 103 may be a server that provides IP services to UE 101 through cellular radio network access. As set forth in the 3GPP, IP Multimedia Subsystem (IMS) is a core network that provides IP multimedia services to UEs over an Internet Protocol (IP) network. IMS application service includes telephony, fax, email, Internet access, voice over IP, instant message, and videoconference. Similarly, Rich Communication Service (RCS) reuses 3GPP specified IMS system as the underlying service platform to provide enhanced messaging services. RCS works with text, images, video, group text messages, and location sharing. RCS also provides an enhanced phone book with service discovery.

Both IMS and RCS contain several application services such as voice call, SMS, IM, DP, etc. over the IP network. UE will send SIP REGISTER to the application server to inform UE's capability. When UE capability change for an IMS/RCS registered UE, UE will send a new SIP REGISTER message with the latest capability to the application server. The SIP message is uplink data which requires an established data radio bearer (DRB). In Some scenario, UE may need to wait for RRC connection Release then request to establish the DRB for sending the pending uplink data of the SIP message. During such process, the registration status between UE and the network is un-sync. As a result, the network may use wrong way to notify UE for acquiring service. In one example, the service attempt may fail. In another example, the service attempt may succeed if the network retries other UE supported way, but the performance is affected.

In accordance with one novel aspect, a solution of establishing a data radio bearer via location update such that a UE can synchronize the UE capability with a network application server is provided. When a UE location changes, the UE will send a location update request to the network for such change including RAT change or service capability change etc. The UE can notify the network to establish the DRB by setting a flag in the location update request while in RRC Idle mode. The UE will set this flag when there is pending uplink data, e.g., a new SIP REGISTER message. As a result, the network can establish the DRB upon receiving the location update request, and then the UE is able to send the new SIP REGISTER message to the application server to synchronize the UE capability without incurring additional delay.

As depicted in FIG. 1, in step 111, UE 101 sends an ATTACH message to MME 102 to attach to the network. In step 112, UE 101 receives an ATTACH ACCEPT message from MME 102. In step 121, UE IMS stack forwards a SIP REGISTER message to UE protocol stack. UE 101 then sends the SIP REGISTER message to the application (IMS/RCS) server 103 (step 122). The SIP registration message notifies which IMS/RCS services UE 101 supports and intends to use. In response, the IMS/RCS server 103 sends an OK message back to UE 101 (step 123), which is then forwarded from the UE protocol stack to the UE IMS stack (step 124). As a result, the IMS/RCS server and the UE are sync with the UE capability with respect to the IMS/RCS services. In step 131, UE 101 (IMS stack) detects that the UE capability changes. There are different scenarios when the UE capability changes. In a first scenario, the UE moves into a new network supporting different capabilities. In a second scenario, a user disables certain functionality on the UE that is previously registered with the network. In step 141, UE 101 (protocol stack) also detects there is a need to send a location update request to the network due to new tracking area/routing area (TA/RA) or RAT change, which triggers a location update (TAU for 4G and RAU for 3G) request to the MME.

In one advantageous aspect, when UE 101 triggers to send the location update request to the network in Idle mode, UE 101 checks whether IMS/RCS capabilities are changed. In step 151, UE 101 sends a location update request to MME 102. If the UE capabilities are changed, then UE 101 set an active flag to be TRUE. When MME 102 receives the TAU request with active flag set to be TRUE, MME 102 starts to establish a data radio bearer for UE 101. In step 152, MME 102 sends a TAU accept back to UE 101, and the DRB has been established for UE 101. In step 161, UE IMS stack forwards a new SIP REGISTER message to UE protocol stack. The new SIP message is uplink data. Because the network has already established a DRB for UE 101, UE 101 is able to sends the new SIP message to the IMS/RCS server 103 over the established DRB in step 162 successfully. In response, the IMS/RCS server 103 sends an OK message back to UE 101 (step 163), which is then forwarded from the UE protocol stack to the UE IMS stack (step 164). As a result, the IMS/RCS server and the UE are synchronized with the UE capability with respect to the IMS/RCS services.

FIG. 2 illustrates simplified block diagrams of a user equipment UE 201 and a base station 202 and a network server 203 in accordance with embodiments of the current invention. BS 202 may have an antenna 226, which may transmit and receive radio signals. RF transceiver module 223, coupled with the antenna, may receive RF signals from antenna 226, convert them to baseband signals and send them to processor 222. RF transceiver 223 may also convert received baseband signals from processor 222, convert them to RF signals, and send out to antenna 226. Processor 222 may process the received baseband signals and invoke different functional modules to perform features in BS/AP 202. Memory 221 may store program instructions and data 224 to control the operations of BS202. BS202 may also include a set of control circuits, such as a control and configuration circuit 211, a scheduler 212, and a resource manager 213 that may carry out functional tasks and features in the network.

Similarly, UE 201 has an antenna 235, which may transmit and receive radio signals. RF transceiver module 234, coupled with the antenna, may receive RF signals from antenna 235, convert them to baseband signals and send them to processor 232. RF transceiver 234 may also convert received baseband signals from processor 232, convert them to RF signals, and send out to antenna 235. Processor 232 may process the received baseband signals and invoke different functional modules to perform features in the UE 201. Memory 231 may store program instructions and data 236 to control the operations of the UE 201. At the network side, application server 203 maybe an IMS server or an RCS server that provides various IMS/RCS application services to UE 201.

UE 201 may also include a set of control circuits that may carry out functional tasks of the present invention. A UE capability synchronization module 290 may detect UE capability change and the un-sync status with the network and triggering corresponding actions accordingly. Capability synchronization module 290 may further comprise a connection configuration circuit 291 that may establish PDN and RRC connections for data/voice services over the IP network, a UE location and capability detector 292 that may detect UE location change including TA/RA/cell/RAT change, and detect capability change including IMS/RCS capability change, a higher layer application (IMS/RCS) stack 293 that provides higher layer functions including registering and publishing UE capabilities, and a lower layer radio network stack 294 that provides lower layer functions including NAS layer attach function and sending TAU/RAU requests to the network for location updates.

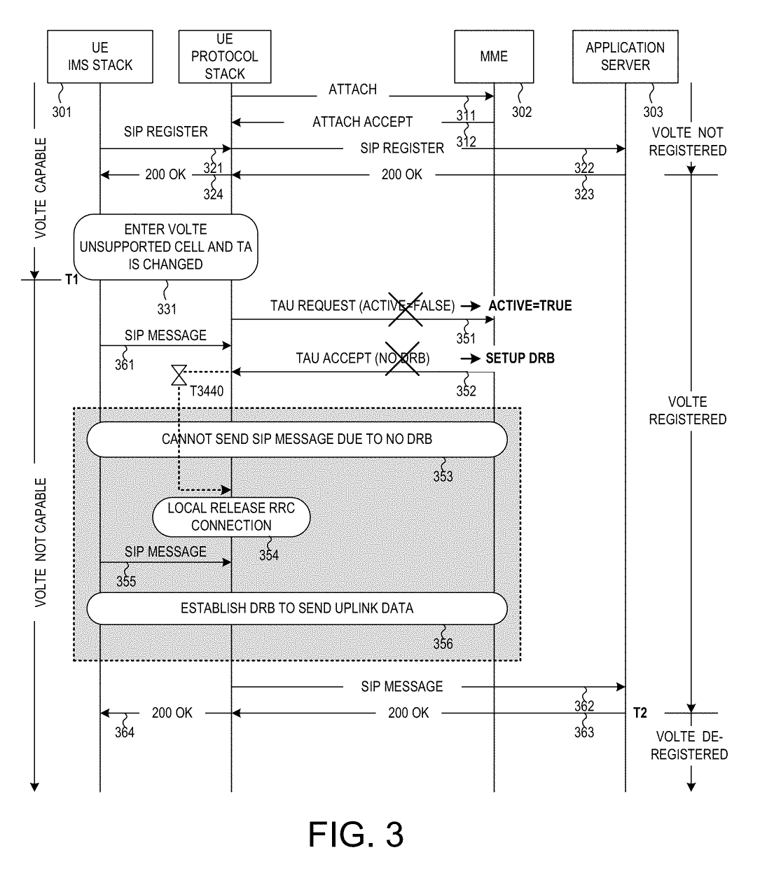

FIG. 3 illustrates a first embodiment of UE capability change when moving to a different cell, which triggers location update in accordance with embodiments of the current invention. In step 311, UE 301 sends an ATTACH message to MME 302 to attach to the network. In step 312, UE 301 receives an ATTACH ACCEPT message from MME 302. UE 301 then enters RRC connected mode. In step 321, UE IMS stack forwards a SIP REGISTER message to UE protocol stack. UE 301 then sends the SIP REGISTER message to the application (IMS/RCS) server 303 (step 322). The SIP registration message notifies which IMS/RCS services UE 301 supports and intends to use. In response, the IMS/RCS server 303 sends an OK message back to UE 301 (step 323), which is then forwarded from the UE protocol stack to the UE IMS stack (step 324). As a result, the IMS/RCS server and the UE are sync with the UE capability with respect to the IMS/RCS services. If there is no uplink/downlink data for a short time (e.g., 20 seconds), then network will notify UE 301 to release the RRC connection and UE 301 enters RRC idle mode.

In step 331, UE 301 (IMS stack) detects that the UE capability changes. In the example of FIG. 3, the UE moves into a new network supporting different capabilities, e.g., entering VoLTE unsupported cell and tracking area is changed. This change triggers a new SIP message to be sent (IMS stack), as well as a location update detected (protocol stack) due to cell and TA change, which triggers a location update (TAU) request to be sent to the MME. In order to send the TAU request, UE 301 needs to setup a signaling radio bearer (SRB) first. After SRB setup complete, UE 301 is in connected mode even there is no data radio bearer (DRB).

For some operator requirement (e.g., delay sending SIP message) or timing issue, the UE lower layer module of the protocol stack may not detect there is pending uplink data when sending the location update request. For example, the new SIP message to de-register VoLTE is forwarded by UE IMS stack in step 361, which occurs after the TAU request sent by UE protocol stack in step 351. As a result, the active flag of the TAU request is set to be FALSE. In step 352, MME 302 sends a TAU accept back to UE 301, without setting up any data radio bearer. Because there is not DRB available for UE 301, UE 301 cannot send the new SIP message to the network in step 353. After the TAU procedure is complete, timer T3440 is triggered. Upon the expiration of timer T3440 (e.g., 10 seconds), UE 301 performs local release of the RRC connection (e.g., one SRB and no DRB) (step 354). In step 355, UE 301 forwards the SIP message again to deregister the VoLTE capability. In step 356, UE 301 establishes a DRB to send the SIP message. In step 362, the SIP message is finally sent to application server 303. In step 363, application server 303 sends an OK message back to UE 301 and completes the VoLTE deregistration. It is noted that under this scenario, from step 331 (time T1) to step 363 (time T2), the UE capability status between UE 301 and IMS/RCS server 303 is unsynchronized. In other words, while UE 301 has not VoLTE capability, the application server 303 is still registered with VoLTE capability for UE 301.

In one advantageous aspect, when UE 301 triggers to send the location update request to the network in Idle mode, UE 301 checks whether IMS/RCS capabilities are changed. That is, before sending the TAU request in step 351, UE 301 checks whether the UE capabilities are changed. If the UE capabilities are changed, then UE 301 set an active flag of the TAU request to be TRUE in step 351. When MME 302 receives the TAU request with active flag set to be TRUE, MME 302 starts to establish a data radio bearer for UE 301. In step 352, MME 302 sends a TAU accept back to UE 301, and the DRB has been established for UE 301. In step 361, UE IMS stack forwards a new SIM REGISTER message to UE protocol stack. The new SIP message is uplink data. Because the network has already established a DRB for UE 301, UE 301 is able to sends the new SIP message to the IMS/RCS server 303 over the established DRB in step 362 successfully. In response, the IMS/RCS server 303 sends an OK message back to UE 301 (step 363), which is then forwarded from the UE protocol stack to the UE IMS stack (step 364). As a result, the IMS/RCS server and the UE are synchronized with the UE capability with respect to the IMS/RCS services. Note that under this scenario, steps 353 to 356 illustrated in the previous scenario can be avoided and the UE capability un-sync time between the UE and the application server can be reduced.

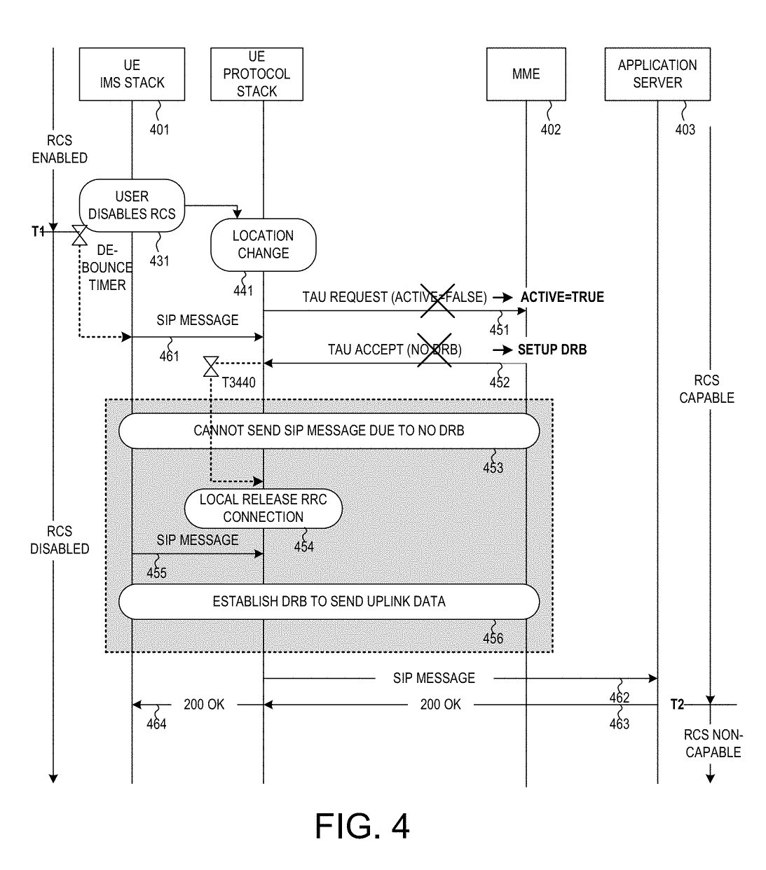

FIG. 4 illustrates a second embodiment of user initiated UE capability change when UE location change, which triggers location update in accordance with embodiments of the current invention. Initially, the IMS/RCS server 403 and the UE 401 are synced with the UE capability with respect to the IMS/RCS capabilities, e.g., the UE is RCS-enabled and is RCS-capable UE. In step 431, a user of UE 401 disables the RCS service capability, which will trigger the UE to send uplink data (SIP message) to the network to notify the latest capability. Meanwhile, in step 441, UE 401 also detects a location change, e.g., from 4G TA1 to 4G TA2, which triggers a location update (TAU) request to be sent to the MME.

For some operator requirement (e.g., delay sending SIP message) or timing issue, the UE lower layer module of the protocol stack may not detect there is pending uplink data when sending the location update request. For example, the new SIP message to disable RCS is forwarded by UE IMS stack to UE protocol stack in step 461 after a de-bounce timer, which occurs after the TAU request sent by UE protocol stack in step 451. As a result, the active flag of the TAU request is set to be FALSE. In step 452, MME 402 sends a TAU accept back to UE 401, without setting up any data radio bearer. Because there is not DRB available for UE 401 in Idle mode, UE 401 cannot send the new SIP message to the network in step 453. Upon the expiration of timer T3440 (e.g., 10 seconds), UE 401 performs local release of the RRC connection (step 454). In step 455, UE 401 forwards the SIP message again to disable the RCS service. In step 456, UE 401 establishes a DRB to send the SIP message. In step 462, the SIP message is finally sent to application server 403. In step 463, application server 403 sends an OK message back to UE 401. It is noted that under this scenario, from step 431 (time T1) to step 463 (time T2), the UE capability status between UE 401 and IMS/RCS server 403 is unsynchronized. In other words, while UE 401 is RCS-disabled, application server 403 still thinks UE 401 is RCS-capable.

In one advantageous aspect, when UE 401 triggers to send the location update request to the network in Idle mode, UE 401 checks whether IMS/RCS capabilities are changed. That is, before sending the TAU request in step 451, UE 401 checks whether the UE capabilities are changed. If the UE capabilities are changed, then UE 401 set an active flag of the TAU request to be TRUE in step 451. When MME 402 receives the TAU request with active flag set to be TRUE, MME 402 starts to establish a data radio bearer for UE 401. In step 452, MME 402 sends a TAU accept back to UE 401, and the DRB has been established for UE 401. In step 461, UE IMS stack forwards a new SIM REGISTER message to UE protocol stack. The new SIP message is uplink data. Because the network has already established a DRB for UE 401, UE 401 is able to sends the new SIP message to the IMS/RCS server 403 over the established DRB in step 462 successfully. In response, the IMS/RCS server 403 sends an OK message back to UE 401 (step 463), which is then forwarded from the UE protocol stack to the UE IMS stack (step 464). As a result, the IMS/RCS server and the UE are synchronized with the UE capability with respect to the IMS/RCS services. Note that under this scenario, steps 453 to 456 illustrated in the previous scenario can be avoided and the UE capability un-sync time between the UE and the application server can be reduced.

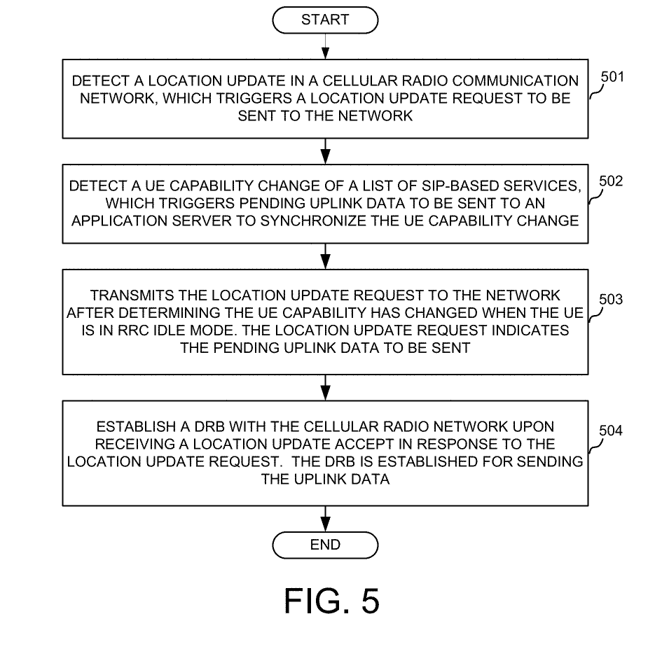

FIG. 5 is a flow chart of a method of establishing data radio bearer using location update for UE capability synchronization in accordance with one novel aspect. In step 501, a UE detects a location update in a cellular radio communication network, which triggers a location update request to be sent to the network. In step 502, the UE detects a UE capability change of a list of session initiation protocol-based (SIP-based) services, which triggers pending uplink data to be sent to an application server to synchronize the UE capability change. In step 503, the UE transmits the location update request to the network after determining the UE capability has changed when the UE is in radio resource control (RRC) Idle mode. The location update request indicates the pending uplink data to be sent. In step 504, the UE establishes a data radio bearer (DRB) with the cellular radio network upon receiving a location update accept in response to the location update request. The DRB is established for sending the uplink data to synchronize the UE capability change with the application server.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
detecting a location update by a user equipment (UE) in a cellular radio communication network, which triggers a location update request to be sent to the network;
detecting a UE capability change of a list of session initiation protocol-based (SIP-based) services, which triggers pending uplink data to be sent to an application server to synchronize the UE capability change;
transmitting the location update request to the network after determining the UE capability has changed when the UE is in radio resource control (RRC) Idle mode, wherein the location update request indicates the pending uplink data to be sent; and
establishing a data radio bearer (DRB) with the cellular radio network upon receiving a location update accept in response to the location update request, wherein the DRB is established for sending the uplink data.

2. The method of claim 1, wherein the list of SIP-based services belongs to IP Multimedia Subsystem (IMS) application service.

3. The method of claim 1, wherein the list of SIP-based services belongs to Rich Communication Service (RCS) application service.

4. The method of claim 1, wherein the UE capability change is detected when a user disables or enables one of the SIP-based services.

5. The method of claim 1, wherein the UE capability change is detected when the UE moves to a new serving cell with changed capabilities.

6. The method of claim 1, wherein the location update is detected when the UE moves to a new tracking area or routing area (TA/RA), a new serving cell, or a new radio access technology (RAT).

7. The method of claim 1, wherein the uplink data is a new SIP REGISTER message for notifying the application server with the UE capability change.

8. The method of claim 7, wherein the UE comprises an application stack stored in a first memory and a protocol stack stored in a second memory, the method further comprises:
forwarding the SIP REGISTER message from the application stack to the protocol stack; and
sending the SIP REGISTER message from the protocol stack to the network, wherein the first memory and the second memory may be part of a single memory unit.

9. The method of claim 8, wherein the SIP REGISTER message is forwarded to the protocol stack after transmitting the location update request.

10. The method of claim 8, wherein the SIP REGISTER message is sent to the network after the DRB is established without performing a local release of a RRC connection.

11. A user equipment (UE), comprising:
a location detecting circuit that detects a location update by a user equipment (UE) in a cellular radio communication network, which triggers a location update request to be sent to the network;
a capability detecting circuit that detects a UE capability change of a list of session initiation protocol-based (SIP-based) services, which triggers pending uplink data to be sent to an application server to synchronize the UE capability change;
a radio frequency (RF) transmitter that transmits the location update request to the network after determining the UE capability has changed when the UE is in radio resource control (RRC) Idle mode, wherein the location update request indicates the pending uplink data to be sent; and
a connection handling circuit that establishes a data radio bearer (DRB) with the cellular radio network upon receiving a location update accept in response to the location update request, wherein the DRB is established for sending the uplink data.

12. The UE of claim 11, wherein the list of SIP-based services belongs to IP Multimedia Subsystem (IMS) application service.

13. The UE of claim 11, wherein the list of SIP-based services belongs to Rich Communication Service (RCS) application service.

14. The UE of claim 11, wherein the UE capability change is detected when a user disables or enables one of the SIP-based services.

15. The UE of claim 11, wherein the UE capability change is detected when the UE moves to a new serving cell with changed capabilities.

16. The UE of claim 11, wherein the location update is detected when the UE moves to a new tracking area or routing area (TA/RA), a new serving cell, or a new radio access technology (RAT).

17. The UE of claim 11, wherein the uplink data is a new SIP REGISTER message for notifying the application server with the UE capability change.

18. The UE of claim 17, further comprising:
an application stack stored in a first memory that forwards the SIP REGISTER message; and
a protocol stack stored in a second memory that sends the SIP REGISTER message to the network, wherein the first memory and the second memory may be part of a single memory unit.

19. The UE of claim 18, wherein the SIP REGISTER message is forwarded to the protocol stack after transmitting the location update request.

20. The UE of claim 18, wherein the SIP REGISTER message is sent to the network after the DRB is established without performing a local release of a RRC connection.
